(19) United States
(12) Patent Application Publication
(10) Pub. No.: US 2008/0236037 A1
(43) Pub. Date: Oct. 2, 2008

(54) PLANTING MIX COMPOSITIONS AND METHODS

(75) Inventors: Bill L. Rose, Hubbard, OR (US); Milan Savich, Beaverton, OR (US)

Correspondence Address: KLARQUIST SPARKMAN, LLP, 121 SW SALMON STREET, SUITE 1600, PORTLAND, OR, 97204, US

(73) Assignees: Rose Agri-Seed, Inc.; Absorbent Technologies, Inc.

(21) Appl. No.: 12/056,156

(22) Filed: Mar. 26, 2008

Related U.S. Application Data
(60) Provisional application No. 60/920,352, filed on Mar. 26, 2007.

(51) Int. Cl. A01C 1/06; A01N 3/00; C08K 11/00

(52) U.S. Cl. 47/57.6; 427/4; 524/15

(57) ABSTRACT

This application provides bulking compositions and methods of making such compositions. In particular examples, such compositions include bulking agents (such as nutshell fragments of filbert or coconut shells) at least partially coated with a binder and super-absorbent polymer (SAP)-particles adhered to the bulking agents by the binder, and can further include seeds at least partially coated with a binder and containing SAP-particles adhered to the seeds by the binder. Also provided are seeds that have adhered thereto SAP-particles and activated charcoal or coir.

### CROSS REFERENCE TO RELATED APPLICATION

This application claims priority to U.S. Provisional Application No. 60/920,352 filed Mar. 26, 2007.

### FIELD

This application relates to planting mix compositions and methods of preparing such compositions that prepare seed for planting, such as compositions that include seeds and bulking agents, each at least partially coated with a super-absorbent polymer (SAP)-containing composition.

### BACKGROUND

Several benefits of treating planting seed have been reported. For example, seeds can be coated to protect and enhance the environment surrounding the natural seed coat. Coating a seed can increase seed germination, improve seedling growth rate, and provide protection during dry spells until growth is established. When planting small seeds, such as bentgrass, at low planting rates, increasing the bulk greatly facilitates accurate seed placement. Seed coatings have been used as carriers for a variety of components, such as agrochemicals, nutrients, and plant growth regulators. In addition, seeds can be treated to reduce incidences of stand loss due to diseases and insects.

The germination of a coated seed is dependent on the seed absorbing moisture after sowing and cracking the coating to allow light and moisture. If the coated layer is not cracked, or it is cracked only with a small width and the seed is not exposed to a satisfactory amount of light, germination will be inhibited. Therefore, compositions are needed that can in some examples increase moisture available to a seed.

### SUMMARY

Seeds are routinely coated to improve seed ‘plant-ability’ and to incorporate seed treatment chemicals and nutrients so they are immediately available to the young seedlings. Maintaining optimum moisture levels can increase the germination of seed. The inventors have found that a mixture containing both seed and bulking agents (such as nutshell fragments or coir), each at least partially coated with a composition that includes super-absorbent polymer (SAP) particles, provides an unexpectedly superior environment for germination. For example, the germination of the seeds can be increased, for example as evidenced by one or more of increased germination rate, earlier seed germination, increased crop growth, or increased crop production.

Seed-bulking compositions are provided, and are generally referred to herein as “bulking compositions.” In one example the composition includes nutshell fragments or other bulking agent (such as coir) at least partially coated with a binder and super-absorbent polymer (SAP) particles adhered to the nutshell fragments or other bulking agent by the binder. Such nutshell fragments can be referred to as “coated nutshell fragments;” however such a term does not require 100% coating of the nutshell surface by either the binder or the SAP particles. The composition can further include seeds at least partially coated with a binder and SAP particles adhered to the seeds by the binder. In some examples, activated charcoal or coir is also adhered to the seeds by the binder. Such seeds can be referred to as “coated seeds;” however such a term does not require 100% coating of the seed surface. In some examples, the coated nutshells (or other coated bulking agent) and the coated seeds are very similar in size. The SAP particles adhered to the seeds or bulking agent (such as nutshell fragments) can be part of a composition (referred to as a SAP-containing composition) that is adhered to the nutshell fragments (or other coated bulking agent) or the seeds by the binder.

Also provided by the present disclosure are methods of making a planting mix. In particular examples, the method includes adhering SAP particles and optionally also activated charcoal to seed (such as grass seed) at least partially coated with a binder, thereby generating coated seed, and adhering SAP particles to a bulking agent (such as nutshell fragments or coir) at least partially coated with a binder, thereby generating a coated bulking agent and coated seed, wherein the coated seed and the coated bulking agent (such as bulking agent particles, granules, or irregular fragments) are approximately equal size (such as very similar in size). The coated seed and the coated bulking agent (such as coated nutshell fragments or granules or coir) are mixed, for example in at ratio of about 50% each, to form a planting mix. In particular examples, the method further includes planting the coated seed-coated bulking agent mixture, thereby improving germination of the seed in the mixture.

The foregoing and other objects and features of the disclosure will become more apparent from the following detailed description, which proceeds with reference to the accompanying figures.

### BRIEF DESCRIPTION OF THE DRAWINGS

FIG. 1 is a digital image of test plots seeded with and equal amount of (left) uncoated seashore paspalum seed or with (right) a coated seashore paspalum seed/coated filbert shell fragment mixture.

FIG. 2 is a bar graph demonstrating that using a mixture containing coated seeds and coated filbert shell fragments provides the same 100% soil coverage with 50% less seeds.

### DETAILED DESCRIPTION

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. For example, the term “comprising a bulking agent” includes single or plural bulking agents and encompasses the phrase “comprising at least one bulking agent.” The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. For example, the phrase “activated charcoal or coir” means including activated charcoal, including coir, or including both activated charcoal and coir.

Unless explained otherwise, all technical and scientific terms used herein have the same meaning as commonly understood by one of ordinary skill in the art to which this disclosure belongs.

Binder: A material used to adhere one agent to another, for example adhere a composition containing SAP-particles to seed or a bulking agent. In a particular example, a binder is not significantly water soluble, for example thereby permitting significant retention of SAP-particles present on seed or a bulking agent in the presence of water. In particular examples, a binder provides a moist environment to which a SAP-containing composition can adhere. A particular non-limiting example of a binder is an alcohol-based binder, such as polyvinyl alcohol.

Bulking agent: Materials that can be added to a population of seed to increase the volume of the seed population. In some examples, such agents improve the physical handling properties of the seed, for example water retention, flowability, water infiltration, drainage, aeration and structure. In some particular examples, such agents are not water soluble. In some examples, bulking agents are in a chunk, crushed, object, particle or granular form. Specific non-limiting examples include nutshells (such as nutshell fragments), coir (from coconuts), vermiculite, perlite, rubber particles (such as tire pieces), and sand, as well as admixtures and combinations thereof. In a specific example, a bulking agent includes or consists of nutshell fragments, such as filbert shell fragments. In a specific example, a bulking agent includes or consists of coir.

Coir: The coarse fiber found between the husk and the outer shell of a coconut. Can be used as a bulking agent to absorb moisture.

Coating: To apply a material to the outer surface of an agent. In particular examples, includes applying a material to the outer surface of a seed or bulking agent (such as a nutshell fragment or coir). However, coating does not require 100% coverage of the surface of the agent; partial coverage can be sufficient. For example, coating can in some examples result in coverage of at least 1% of the surface by the material, such as at least 10%, at least 20%, at least 50%, at least 80%, at least 95%, or at least 99% coverage of the surface of the desired (such as a seed or nutshell fragment).

A coating material can be directly applied to the agent (for example by incubating the coating material with the agent to be coated), or indirectly applied (for example by adhering a first material to the surface of the agent to be coated that permits attachment of a second material, and then adhering the second material to the agent already coated with the first material).

In one particular example, coating does not result in significant or any penetration of the covering or coating into the agent, such as penetration of a seed, shell, or bulking agent. In some examples, the thickness of a coating applied is at least 0.01 mm, for example at least 0.05 mm, such as about 0.01 mm to 0.1 mm. In particular examples, coating an agent alters the properties of the agent, for example to increase the ability of the agent to retain or absorb moisture.

Germination: The sprouting of a plant seed into a seedling, for example from a grass seed into a plant.

Germination rate: The proportion of seeds in a given batch or lot of seed that germinate. For example, a germination rate of 50% indicates that about 50% of the seeds in the batch will germinate when planted under conditions that permit germination.

Nutshell: The shell or hard external covering which encloses the kernel of a nut. Nutshells can be obtained from any desired nut, such as filberts (hazelnuts), pine nuts, pistachios, pecans, walnuts, Brazil nuts, coconuts and almonds. Nutshells are often a waste product of nut manufacturers. Nutshell fragments can be obtained using routine methods, such as by manipulation of the shell into smaller particles, fragments, or granules. For example, nutshells can be ground or subjected to other physical manipulation or can be treated chemically, to generate fragments of the nutshell or shell product (e.g., coir from coconuts). A substantially uniform population of nutshell fragments can be obtained, for example by passing the fragments through a mesh screen (such as those used in cleaning the desired seed).

Seed: The ripened ovule of gymnosperm or angiosperm plants, and includes the embryo and its proper coats and can also include the seed coat (an outer protective covering). Seeds are very diverse in size and shape. The disclosure is not limited to particular plant seeds, and can include for example grass seeds, flower seeds, tree seeds, and vegetable seeds. In a specific example, the seed is a grass seed, such as a seashore paspalum grass seed.

Super-absorbent polymer (SAP): Materials that imbibe or absorb large quantities of aqueous fluid (such as water), for example at least 10 times their own weight, and that retain the imbibed or absorb aqueous fluid under moderate pressure. Generally, SAPs are water-insoluble polymers which swell or gel in aqueous fluids but do not dissolve in the fluids. Some SAPs can absorb up to 1000 times their weight in aqueous fluid. These polymers are typically lightly cross-linked polymers, which contain a multiplicity of acid functional groups such as carboxylic acid and carboxamide acid groups.

Exemplary SAPs include totally synthetic copolymers (such as those made by copolymerizing acrylic acid and acrylamaide in the presence of a coupling agent), starch graft copolymers (such as those that use a natural polymer, such as starch to form an SAP product including a starch graft copolymer), and starch-based SAPs (such as those described in US Patent Application No. 2005/0159315, herein incorporated by reference as to the composition of the starch-based SAP, for example Zeba® available from Absorbent Technologies, Inc., Oregon).

A SAP-containing composition is a composition that includes SAPs, such as SAP-particles. Such a composition can be adhered to seed or bulking agents, for example by first at least partially coating the seed or bulking agent with a binder to which the SAP-containing composition can bind. In particular examples, the SAP-containing composition includes other agents, such as activated charcoal, filler (for example calcium carbonate, clay, gypsum, bentonite, dry diatomaceous earth, coir, or combinations or admixtures thereof), growth-promoting agents (for example fertilizers, pesticides, growth hormones, nutrients, or combinations or admixtures thereof), coloring agents, or combinations thereof.

### Bulking Compositions

The present disclosure provides bulking compositions. In particular examples, such compositions can be added to bulk seed to increase the volume of the seed mixture, such as an increase of at least 10%, at least 20%, at least 50%, at least 75%, or at least 100%. In some examples, a bulking composition increases germination of seed present in the composition, such as seed at least partially coated with a binder to which SAPs are adhered (herein referred to as “coated seed”). In particular examples, coated seed present in the disclosed bulking compositions have increased germination, for example as compared to uncoated seed or to coated seed in the absence of the other components of the composition, such as an increase in germination of at least 20%, at least 30%, at least 40%, at least 50%, at least 75%, or at least 100%. In some examples, increased germination is evidenced by one or more of increased germination rate, earlier seed germination, increased crop growth, or increased crop production.

In particular examples, the bulking composition includes one or more bulking agents (such as nutshell fragments or coir) that are at least partially coated with a binder and SAP particles adhered to the bulking agents by the binder (referred to herein as coated bulking agents, such as coated nutshell or coated coir fragments). The SAP particles can be part of a composition (referred to herein as a SAP-containing composition or coating), wherein the composition is adhered to the at least partially binder-coated bulking agent fragments via the binder.

SAPs are agents that can absorb aqueous fluids and retain the fluid under moderate pressure, such as water-insoluble hydrogel-forming polymers which swell aqueous fluids but do not dissolve in the fluids. SAPs are known in the art, and the disclosure is not limited to particular SAPs. Examples of SAPs that can be used include but are not limited to cross-linked polyacrylamide polymers (such as Broadleaf P4, SANWET IM-300 and IM-1000, AQUASTORE, AGRIGEL, and GROWSOAK 400, seaweed based products (such as ALGINURE), starch graft copolymers, and starch-based SAPs. In a specific example, the SAP is a starch-based SAP, such as those described in US Application No. 2005/0159315 (herein incorporated by reference as to the starch-based SAP compositions), for example Zeba® (Absorbent Technologies, Inc., Oregon). The concentration of SAP to be used in the SAP-containing composition can be determined by those skilled in the art. In one example, the SAP-containing composition adhered to bulking agents can include about 0.5% to 5%, SAP or 1 to 5% SAP, such as 2 to 5%, 2.5 to 5%, or 3 to 5% SAP by weight of the bulking agents.

The SAP-containing composition adhered to the nutshell fragments or other bulking agent by the binder can include other agents. In one example, the SAP-containing composition includes other bulking agents or fillers, such as one or more of calcium carbonate, clay, gypsum, bentonite, coir, and dry diatomaceous earth (or admixtures thereof). The bulking agents or filler present in the SAP-containing composition can be uncoated, at least partially coated with a binder to which SAP-particles are adhered, or a combination of both uncoated bulking agents and bulking agents at least partially coated with a binder to which SAP-particles are adhered. In particular examples, such agents make up at least 85% of the composition by weight, such as at least 90% of the composition by weight, for example about 90 to 99%, 95 to 99%, 95 to 98% or 95 to 97% by weight of the composition.

In one example, the ratio of bulking agents (such as nutshell fragments or coir) to the SAP-containing composition adhered to the bulking agents is about 1 to 1 by weight, about 0.5 to 1 by weight, about 0.25 to 1 by weight, about 1 to 0.5 by weight, or about 1 to 0.25 by weight.

In a particular example, the bulking agent includes nutshell fragments, such as nutshell granules, including mixtures of shells from different nuts. Nutshells can be obtained from any nut, such as a filbert, almond, walnut, macadamia, pine nut, pistachio, pecan, Brazil nut, coconut, or combination thereof. Nutshells can be processed into smaller particles or granules or irregular pieces. For example, they can be ground or otherwise fragmented into nutshell particles or fragments. For example, nutshells can be mechanically ground into smaller particles using methods known in the art, such as a hammermill or tub grinder. In a particular example, a nutshell is not treated chemically to generate nutshell fragments. For example, a nutshell can be mechanically ground into smaller particles and screened to roughly the size of a desired seed and then mixed with the nutshell. In particular examples, the coated nutshell fragments are about 0.1 mm to 10 mm in diameter, for example 0.5 mm to 7 mm in diameter, or 0.5 mm to 2 mm in diameter.

The bulking composition that includes coated nutshell fragments (or other bulking agent) can include other agents. For example, the bulking composition can include one or more growth-promoting additives, such as fertilizers, pesticides (such as a fungicide), growth hormones, soil-based nutrients, or combinations thereof, as well as colorants.

In one example, the bulking composition also includes seeds, such as seeds at least partially coated with a binder by which SAP particles are adhered to the seed (herein referred to as “coated seed”). In some examples, the coated seed also includes adhered activated charcoal. The activated charcoal can be part of the SAP-containing composition or the activated charcoal can be adhered to the seed via the binder in a separate step. In a particular example, the amount of activated charcoal added to the seed is at least a 1:1 ratio by weight of charcoal to seed (such as a ratio of about 2:1, 4:1, 5:1 or 10:1). In particular examples, the SAP-containing composition adhered to the seeds via the binder is the same SAP-containing composition adhered to the bulking agents (such as nutshell fragments).

In particular examples, the coated seeds and coated nutshell fragments (or other bulking agent) are approximately equal size, such as about 0.5 mm wide and 2 mm long or about 3.5 mm wide and 7 mm long. In a specific example, the resultant coated seed is similar in size to a wheat kernel, such as about 5 mm long by 2.5 mm deep, such that the resultant coated seed can be planted using machinery used to plant wheat, for example at a rate of about 100 lbs coated seeds per acre. To obtain such uniformity, coated seeds and coated nutshell fragments (or other bulking agent such as coir) can be placed through the same mesh sieves, and the desired sized particles collected.

The disclosure is not limited to particular seeds. Any plant seed can be at least partially coated with a binder to which SAP-particles (and in some examples also activated charcoal) are adhered. Exemplary seeds include those that can germinate into flowers, trees, grasses (such as fescue (for example fine and tall fescue), seashore paspalum, ryegrass, forage grass, and bluegrass), and those used to plant crops (such as soy, beans, cotton, tobacco, tomatoes, corn, melon, rye, and wheat) or any seed that can benefit from this method. In a specific example the seed is a grass seed, such as a seashore paspalum grass seed, for example, the seashore paspalum ‘Sea Spray’ variety. In one example the seed is seashore paspalum ‘Sea Spray’ seed deposited at American Type Culture Collection (ATCC) under Accession No. PTA-6827.

Various ratios of the coated bulking agents (such as nutshell fragments or coir) and the coated seed can be present in the composition. In some examples, the coated seeds and coated bulking agents (such as nutshell fragments or coir) are present in the composition at a ratio of about 50% each by weight (that is a ratio of about 1 to 1). In other examples, the coated seeds and coated bulking agents (such as nutshell fragments or coir) are present in the composition at a ratio of about 2 to 1, 3 to 1, 4 to 1, 5 to 1, 10 to 1, 15 to 1, 1 to 2, 1 to 3, 1 to 5, or 10 to 5 of coated seed to coated bulking agents (such as nutshell fragments or coir) by weight.

In a specific example, the bulking composition includes coated filbert shell fragments and coated grass seeds (e.g., seeds coated with coir or activated charcoal), wherein the shells and seeds are at least partially coated with an alcohol-based binder (such as PVOH), to which a SAP-containing composition is adhered (such as a SAP-containing composition that includes 1 to 5% SAP, such as 2 to 3% SAP, for example Zeba®). In another specific example, the bulking composition includes coated filbert shell fragments and coated grass seeds, wherein the shells are at least partially coated with an alcohol-based binder (such as PVOH), to which a SAP-containing composition is adhered (such as a SAP-containing composition that includes 1 to 5% SAP, such as 2 to 3% SAP, for example Zeba®), and the seeds are at least partially coated with an alcohol-based binder (such as PVOH), to which a SAP-containing composition is adhered (such as a SAP-containing composition that includes 1 to 5% SAP, such as 2 to 3% SAP, for example Zeba®, and activated charcoal, for example a ratio of at least 1:1 (w/w) of activated charcoal to seed, such as a ratio of at least 2:1, at least 3:1, at least 5:1, at least 7:1 or at least 10:1 (w/w)).

### Methods of Producing a Planting Mix

Methods of producing a planting mix are provided. In particular examples, the planting mix increases the germination of seed in the planting mix (wherein the seed is at least partially coated with a binder by which SAPs and optionally activated charcoal are adhered). Indications of increased germination include, but are not limited to, earlier seed germination or blooming, decreased irrigation requirements, increased germination, increased crop growth, increased crop production or yield, increased plant size, increased germination rate, or combinations thereof. For example, increased germination can be relative to seed not containing binder or SAP, or to seed at least partially coated with binder but no SAP-containing composition (or a composition that does not include SAP), such as an increase of at least 20%, at least 50%, or at least 75%.

In particular examples, the method includes at least partially coating seed and one or more bulking agents with a binder by which SAPs are adhered, thereby generating coated seed and coated bulking agent. For example the SAPs can be present in a SAP-containing composition. In particular examples, the same SAP is adhered to the seed and the bulking agent. For example, the methods described above for preparing coated bulking agents can be used to prepare coated seeds. In some examples, coated seeds also include adhered activated charcoal or coir. The resulting coated seed and coated bulking agent are mixed together, to form a planting mix composition that includes coated seed-coated bulking agent. In particular examples, the method can further include planting the coated seed-coated bulking agent mixture, thereby improving germination of the seed and assisting in accurate planting of the seed.

In particular examples, the coated seed and the coated bulking agent are approximately of equal size, that is, substantially the same size. For example, the coated seed and the coated bulking agent can be within +/−1 mm, +/−0.75 mm, +/−0.5 mm, or +/−0.1 mm of one another. Methods for achieving this uniformity include placing the coated seeds and coated bulking agent through the same mesh sieves, thereby resulting in a population of coated seeds and coated bulking agents that are very similar in size. In a particular example, the coated seed and coated bulking agent are approximately the same size as a wheat kernel, for example about 5 mm long and 1.5 m in depth.

As discussed above, the disclosure is not limited to use of particular seeds. Seeds from any plant can be used. Exemplary seeds are described above. In addition, the seed can include a mixture of different types of seeds, such as a mixture of different grass seeds. In a specific example, the seed is a grass seed, such as a seashore paspalum seed.

Also as discussed above, the disclosure is not limited to use of particular SAPs. Any SAP can be used, as long as it is not significantly toxic to the seeds or plants. Exemplary SAPs are described above. For example, the SAP can be a starch-based SAP, such as Zeba®. In a particular example, the seed and bulking agent are at least partially coated with a binder to which a SAP can adhere. In particular examples, the SAPs are present in a SAP-containing composition that is incubated with the at least partially binder-coated seeds or at least partially binder-bulking agent, such as a composition that includes SAP at a concentration of 1 to 5% of the weight of the seed or the weight of the bulking agent, such as 2% to 5%, 2 to 3% or 2.5 to 3% of the weight of the seed or the weight of the bulking agent. In some examples, the SAP-containing composition adhered to the seeds also further includes activated charcoal, for example a ratio of about 1:1 or 10:1 (w/w) of activated charcoal to seed.

In particular examples, the method of making a planting mix includes mixing the composition described above (those including coated bulking agents, such as coated ground nutshells or coated coir) with coated seed (which includes adhered SAPs and in some examples also adhered activated charcoal), wherein the coated seed and the coated bulking agent are approximately equal size, thereby generating a planting mix.

In very specific examples, the method includes coating grass seed (such as ATCC Accession No. PTA-6827) and ground nutshells (such as ground filbert shells or ground coir) at least partially with a binder, and adhering a SAP-containing composition (such as a composition that includes 1-5% SAP, for example 2.5%-5% SAP by weight of the nutshells or seed, and in some examples optionally includes at least 1:1 (w/w) activated charcoal:seed), thereby generating coated grass seed and coated ground nutshells or coir. In particular examples, the same SAP (for example Zeba®) is adhered to the grass seed and the ground nutshells or coir. The resulting coated grass seed and coated ground nutshells (and in some examples also coated coir) are mixed together to form a planting mix composition that includes coated grass seed and coated ground nutshells, and in some examples further includes coated coir.

### Bulking Agents

Bulking agents that can be used include those that can increase the volume of seed. In exemplary embodiments, a bulking agent is not water soluble. In some examples, such as agents alone do not promote or inhibit growth or germination of a plant. Particular non-limiting bulking agents that can be used in the methods provided herein include nutshells, coir, vermiculite, perlite, rubber (such as pieces of tires), sand, or combinations thereof. Such agents can be in a chunk, crushed, object, particle or granular form, for example.

In a specific example, the bulking agent includes or consists of ground nutshells, such as ground filbert nutshells or ground coconut shells (e.g., coir).

### Coating Seeds and Bulking Agents

Methods of coating a seed and other materials, such as bulking agents, are known in the art. For example, commercially available coating equipment is capable of producing a coating on the seed and bulking agents. Exemplary types of coating equipment are a ribbon/paddle blender, an inclined rotary pan-type, and a rotostat mixing chamber.

In particular examples, an adhesive or binder is first applied to the seeds and bulking agents under conditions that permit at least partial coating of the seeds/bulking agents with the binder. This will allow a SAP-containing composition and in some examples also activated charcoal or coir, to adhere to the seeds/bulking agents, for example by creating a favorable moist surface for the SAP-containing composition to adhere. For example, raw seed or bulking agents can be exposed to the binder for a time sufficient to obtain at least partial coverage (for example at least 10%, at least 20%, at least 50%, at least 75%, at least 90% or at least 99% coverage) on each seed and bulking agent particle. Typically, exposure to the binder occurs at room temperature (such as about 20-30° C.). In particular examples, the raw seed or bulking agent particles are exposed to the binder for at least 3 minutes, at least 4 minutes, or at least 5 minutes, no more than 20 minutes, no more than 10 minutes, such as 3 to 10 minutes, 5 to 10 minutes, or 5 to 8 minutes.

In some examples, the binder material is inert to the seed, for example does not significantly impair seed germination. In particular examples, the binder is alcohol-based, and not water-based. Alcohol-based binders are known in the art. Exemplary alcohol-based binders include polyvinyl alcohol (PVOH) or a similar material within the same class used in the seed coating industry (such as polyvinyl acetate and others within this category). Most binders, such as PVOH, come in a powder form which can be mixed into the appropriate solution before use. For example, PVOH adhesives, such as the powder products Celvol® (Celanese Corporation) and BF17 (Kel Chemical), are known in the art. Liquid versions of these products can be used if mixing a solution from the powder form is not desirable.

The amount of binder solution applied to the seeds and bulking agent particles can affect the quality of the coating: too much binder will result in lumps, while inadequate amounts of binder will cause the coating to dust off, offer low durability and low buildup. Ideally, the adhesive will not impair seed germination, will give seeds or bulking agents a durable coating when dry, and will be readily soluble in water so that the coating will not stick on the seed or bulking agents once wet.

In particular examples, the amount of binder added is about 1% to 10% in weight of the total seed or bulking agents to be coated, such as about 2% to 7%, or about 3% to 6%. In some examples, the larger the seed or bulking agent particle to be treated, the higher the percentage of binder used. For example, using 5 to 6 pounds of PVOH to 100 pounds of alfalfa or grass seeds provides a sufficiently moist surface for the filler composition to adhere. Those skilled in the art appreciate how to determine optimal amounts of binder and moisture levels to use.

The seeds and bulking agents, which in some examples are at least partially coated with binder, are exposed to SAP-containing composition under conditions that permit SAPs to adhere to the seed/bulking agent, and in some examples also permits activated charcoal or coir to adhere to the seed. In particular examples, the SAP-containing composition includes finely ground mineral material, which will adhere to the moist surface of the seed or bulking agent, thereby coating the seed or bulking agent. In particular examples, this mineral content does not substantially dissolve in water and keeps the moist seeds or bulking agents from sticking to each other. Among the exemplary particulate solids are calcium carbonate, clay, gypsum, bentonite, and dry diatomaceous earth. These solid materials generally do not chemically change the content of the seed hull or germplasm.

If desired, other additives can be included in the SAP-containing composition to be applied to the seeds and bulking agent. Particular examples include growth-promoting agents, such as agents that increase the survival rate and health of the young plants. Examples include nutrients, fertilizers, fungicides, herbicides, pesticides, trace elements, growth hormones or combinations thereof. Nutrients routinely used in commercial grass seed coatings include but are not limited to N, P, K, S, Fe and Zn. In acidic soils, lime coatings for seeds can be beneficial to seedling performance. The conventional seed coating percentage is about 33% (such as a seed to fill ratio of 1 to 0.5) for small-seeded legume seeds to about 50% (such as a seed to filler ratio of 1:1) for grass seeds. Similar ratios can be used for bulking agents (such as nutshell granules or coir) to filler. In particular examples, the amount of SAP-containing composition exposed to the seeds or bulking agent is an amount approximately equal to the weight of the seeds or bulking agent (for example, if the seeds weigh 100 lbs, 100 lbs of SAP-containing composition is used to adhere SAP to the seeds).

In a particular example, activated charcoal is also adhered to the binder on the seeds. For example, activated charcoal can be present in the SAP-containing composition, for example present at a ratio of at least 1:1 (w/w) activated charcoal:seed, such a ratio of at least 2:1 or at least 4:1. Alternatively, activated charcoal can be adhered to seeds separately from the SAP containing-composition. For example, the amount of activated charcoal exposed to the seeds can be an amount at least 4 times the weight of the seeds (for example, if the seeds weigh 100 lbs, 400 lbs of activated charcoal is adhered to the seeds).

The seed or bulking agents (which in some examples are at least partially-coated with a binder), are mixed with a SAP-containing composition to adhere the SAP-containing composition to the seed or bulking agent. Methods that permit such binding are known in the art. For example, the seed or bulking agent can be tumbled (for example in a drum), and the SAP-containing composition slowly added, for example by applying the SAP-containing composition upon the seeds or bulking agent (such as by spraying). The equipment can be run until the seed or bulking agent is at least partially coated (such as at least 25%, at least 50%, at least 80%, at least 90%, or 100% coated), for example for at least 5 minutes, at least 10 minutes, such as 10 to 12 minutes. Similar methods can be used to adhere activated charcoal or coir to seeds and bulking agents, for example if SAPs and activated charcoal or coir are adhered in two separate stages.

If desired, the seed or bulking agent can be colored with an agent (such as a pigment or dye) to identify the coated seed or coated bulking agent. Ideally, the coloring agent will not significantly inhibit germination or other desirable biological activity of the seed. This colorant can be incorporated into the SAP-containing composition, or into the binder composition. Alternatively, the colorant can be applied after the seed or bulking agent is coated. An exemplary colorant is aqua-blue. In some examples, if activated charcoal is adhered to the seeds, no additional colorant is added.

The SAP-containing composition on the seed or bulking agent can be compacted onto the seed or bulking agent using methods known in the art. Such compacting can be performed to reduce the amount of coating ‘flaking off, for example during transit or handling of the seed or bulking agent. For example, the coated seed or the coated bulking agent can be fed into a mechanism, such as an inclined drum, to compact the coating. In one example, the coated seeds or coated bulking agents are rolled on themselves (for example in a steel drum), thereby compacting the coating.

After the seed and bulking agent are at least partially coated with binder, have SAPs (and in some examples activated charcoal or coir) adhered, and are compacted, the coated seed or coated bulking agent can be dried. For example, drying can significantly reduce imbibing of moisture by the seed, thereby reducing unwanted pre-germination. In addition, drying can rapidly draw-off moisture without using excessive heat (which can kill the seed). Methods of drying are known in the art, for example using a large fluid bed dryer or forced hot air system. Depending on the type of drying equipment, temperatures for drying the coated seed can be as high as 180° F. for a short time, such as 5 minutes or less, such as 1 to 5 minutes or 1 to 3 minutes.

After drying, the coated seed and coated bulking agents are screened for size, and can be bagged. In particular examples, the coated seed and coated bulking agents can be screened using the same method, such as the same mesh screens. The desired-sized particles can be selected. At this point the weight and size of the seed and bulking agent has increased, but the finished coated seed or bulking agent remains principally the same shape as it was prior to coating.

In particular examples, the total time to coat and process a batch of seed or bulking agent takes about 20 to 25 minutes.

### EXAMPLE 1

### Generation of Coated Seeds

This example describes methods used to adhere Zeba® superabsorbent polymer particles to seashore paspalum ‘Sea Spray’ grass seeds. One skilled in the art will recognize that similar methods can be used to generate coated seeds from other grasses or other plants.

Zeba® was adhered to the seed via a binder to increase the amount of moisture absorbed into the seed coating layer. With Zeba®, cracking will occur in 2 or 3 ‘block’ portions, increasing the opportunities for light and moisture penetration and thereby providing greater chance of germination. Only a relatively small amount of Zeba® is needed to provide these benefits; Zeba® was applied at a rate of 2½% to 3% of the weight of the seed.

An adhesive or binder was used to adhere the Zeba® coating to the seed, by creating a favorable moist surface for the SAP-containing composition (Zeba® powder and filler material). Because Zeba® is a superabsorbent product and absorbs water very readily, polyvinyl alcohol (PVOH) was used as the binder (such as Celvol® (Celanese Corporation) and BF17 (Kel Chemical)). A rate of 5 to 6 pounds of powder PVOH to 100 pounds of grass seed was used to provide a sufficiently moist surface for the SAP-containing composition to adhere. The raw seed was exposed to the PVOH binder for 5 to 8 minutes at room temperature to obtain thorough coverage on each seed piece using blending.

The moist seeds coated with PVOH were contacted with the SAP-containing composition, which included finely ground mineral filler material (plus other additives as desired, for example calcium carbonate, clay, gypsum, bentonite, and dry diatomaceous earth) and Zeba®. The mineral material does not substantially dissolve in water and was used to keep the moist seeds from sticking to each other.

After at least partially coating the seed with PVOH, the SAP-containing composition (finely ground filler base-mineral and additives, including Zeba®) was exposed to the seed. While the seeds were being tumbled in a drum, the SAP-containing composition was applied to the seeds. The amount of finely ground mineral material and Zeba® needed were measured beforehand, and mixed together into a single SAP-containing composition. This ensured that the seeds did not stick to each other and the coating was more consistent. Approximately 100 lb seed was contacted with approximately 100 lb of the SAP-containing composition. Coir can be added to improve the speed of water absorption when germination is desired. The seeds were tumbled with the SAP-containing composition for about 10 to 12 minutes. This resulted in a coated seed (though 100% coverage by the SAP-containing composition is not required).

The surface of the coated seed can be colored with an agent such as a pigment or dye to identify the coated seed. In a specific example, the colored agent was aqua-blue.

The seed was fed into an inclined drum to compact the seed coating and reduce the amount of filler material ‘flaking off’ later in transit or as the seed is handled.

The coated seeds were then immediately dried before too much moisture was imbibed by the seed, causing unwanted pre-germination. A large fluid bed dryer or forced hot air system was used. Coated seeds were heated at 180° F. for 5 minutes or less.

After drying, the coated seed was then screened for size and can be bagged for shipment. The resulting seed's weight and size has increased, but the finished coated seed remained principally the same shape as it was prior to coating.

The total time to coat and process a batch of seed took no longer than 20 to 25 minutes.

### EXAMPLE 2

### Grinding Nut Shells

This example describes methods used to crush filbert (hazelnut) shells, which are a waste-product produced by filbert producers. One skilled in the art will recognize that similar methods can be used to crush other types of nutshells (such as pecan, walnut, coconut, or macadamia shells).

Shells were fed into a tub grinder with the appropriate screen and then processed through the screens indicated for the crop of interest. For example, when the nutshells were being used with seashore paspalum ‘Sea Spray’ grass seeds, the screens used were 12/64 inch mesh.

### EXAMPLE 3

### Generation of Coated Nutshell Fragments

This example describes methods used to at least partially coat the nutshell fragments produced in Example 2 with a binder and then adhere a SAP-containing composition to the seed via the binder. One skilled in the art will recognize that similar methods can be used to coat other types and sizes of nutshell fragments. For example, such methods can be used to coat coir.

PVOH was used to adhere the SAP-containing composition to the nutshells (such as Celvol® or BF17). A rate of 5 to 6 pounds of powered PVOH to 100 pounds of nutshell fragments was used. The nutshell fragments were exposed to the PVOH for 5 to 8 minutes at room temperature to obtain thorough coverage on each nutshell fragment.

The nutshell fragments that were at least partially coated with PVOH (an in some examples were completely coated with PVOH) were incubated with the SAP-containing composition, which included finely ground mineral material (plus other additives as desired, such as calcium carbonate, clay, gypsum, bentonite, and dry diatomaceous earth) and Zeba®. While the nutshell fragments coated with PVOH were being tumbled in a drum, the SAP-containing composition was applied to the nutshell fragments coated with PVOH. The amount of finely ground mineral material and Zeba® needed in the SAP-containing composition were measured beforehand, and mixed together into a single SAP-containing composition combination. This ensured that the nutshell fragments did not stick to each other and the coating was more consistent. Approximately 100 lb PVOH-coated nutshell fragments was contacted with approximately 100 lb of the SAP-containing composition. The PVOH-coated nutshell fragments were tumbled with the SAP-containing composition for about 10 to 12 minutes. This results in coated nutshell fragments (though 100% coverage by the SAP-containing composition is not required).

The surface of the coated nutshell can be colored with an agent such as a pigment or dye to identify the coated nutshell, for example using aqua blue.

The coated nutshell fragments were fed into an inclined drum to compact the coating and reduce the amount of filler material ‘flaking off’ later in transit or as the nutshell fragments are handled. The coated nutshell fragments were then immediately dried using a large fluid bed dryer or forced hot air system. Coated nutshells were heated at 180° F. for 5 minutes or less.

After drying, the coated nutshells were screened for size and can be bagged for shipment. The resulting nutshell fragments' weight and size has increased, but the finished coated nutshell fragments remain principally the same shape prior to coating.

The total time to coat and process a batch of nutshell fragments took no longer than 20 to 25 minutes.

### EXAMPLE 4

### Compositions that Include Coated Seeds and Coated Nutshell Fragments

This example describes a composition that includes the coated seeds of Example 1 and the coated nutshell fragments produced in Example 3. One skilled in the art will recognize that similar methods can be used to produce similar compositions with other seeds and nutshells.

A ratio of 1:1 SAP-coated seashore paspalum seed: SAP-coated filbert nutshells were mixed. The nutshells and seed were approximately the same size ( 10/64 to 12/64 inches).

### EXAMPLE 5

### Planting and Germination of Coated Seeds and Nut Shells

This example describes methods used to plant the composition described in Example 4, and the results of a comparative trial. One skilled in the art will recognize that similar methods can be used to plant and germinate similar compositions with other seeds and nutshells.

A mixture containing a ratio of 1:1 coated seashore paspalum ‘Sea Spray’ seeds to coated filbert shell fragments were seeded at a rate of 1 lb/1000 ft² (that is ½ lb of coated seed and ±2 lb of coated shells per 1000 ft²) on a plot of 196 ft² in Kahului, Maui, Hi. A parallel plot of 196 ft² in Kahului, Maui, Hi. was seeded with uncoated seashore paspalum ‘Sea Spray’ seeds at a rate of 1 lb uncoated seeds/1000 ft². Previously (about 30 and 12 days prior to seeding), the plots were sprayed with RoundUp® glyphosate spray.

The mixture of coated seeds/coated nutshells or the uncoated seeds was combined with 2 gallons of compost for better distribution. The plots were raked in three directions to bury the mixture. Plots watered using sprinklers for 20 minutes, and thereafter irrigated 7-times per day at 6 am, 12 pm, 2 pm, 3 pm, 4 pm, and 5 pm for five minutes each. The day after seeding, Verdicon® fertilizer 24-6-12+10.9% S+3.1% Fe+1.0% Mg (12% polymer coated sulfur coated urea) was applied to both plots at a rate of 2 lbs/1000 ft² (741 g/196 ft²). The plots were raked in three directions to incorporate the fertilizer. Subsequently, germination and the % soil coverage was monitored in both plots (Table 1).

TABLE 1
Germination of uncoated vs. coated ‘Sea Spray’ seeds.

| | Temperature | % Soil Coverage | |
|---|---|---|---|
| Date | (Min/Max) | Uncoated | Coated |
| 8/19 | 21 C/28 C | Germination began | Germination began |
| 8/22 | 17 C/30 C | 1-2 leaf stage | 1-2 leaf stage |
| 8/25 | 18 C/29 C | 2-3 leaf stage | 2-3 leaf stage |
| 8/31 | 19 C/32 C | | |
| 9/2 | 20 C/30 C | 40% | 30% |
| | | soil coverage | soil coverage |
| 9/4 | 21 C/30 C | 60% | 40% |
| 9/9 | 21 C/30 C | 80% | 60% |
| 9/12 | 23 C/28 C | 90% | 75% |
| 9/17 | 20 C/30 C | 95% | 80% |
| 9/21 | 18 C/28 C | 98% | 90% |
| 9/26 | 18 C/32 C | 100% | 95% |
| 10/4 | 19 C/30 C | 100% | 95% |
| 10/16 | 18 C/28 C | 100% | 100% |

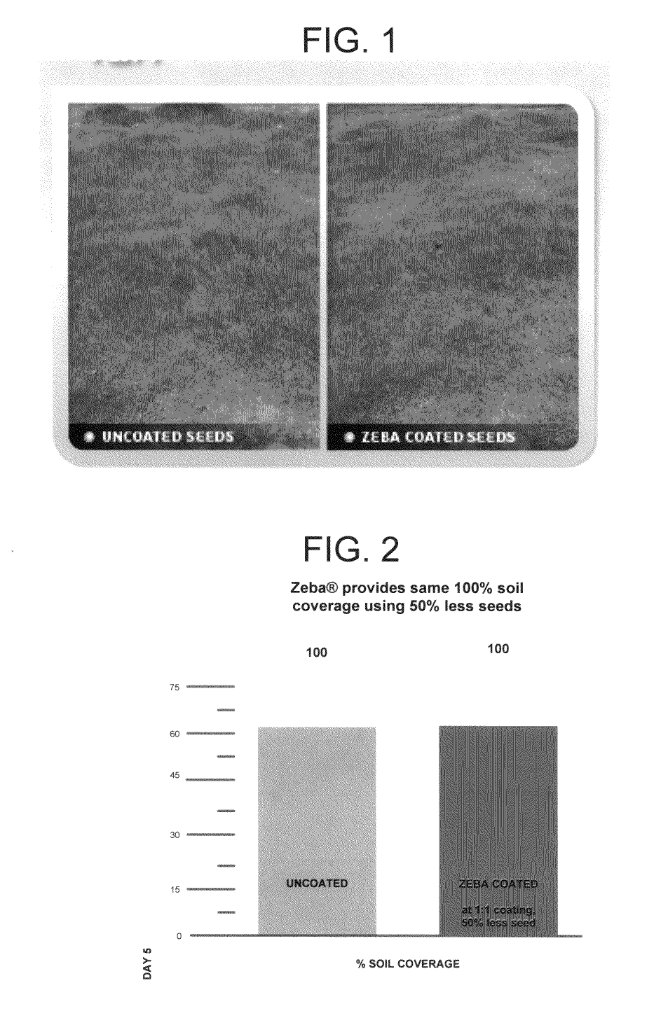

As shown in FIGS. 1 and 2, only 50% of the coated seed-coated nutshell mixture was required to provide the same 100% soil coverage obtained by non-coated seeds. Therefore, a mixture containing coated seeds and coated nutshell fragments can provide the same 100% soil coverage using 50% less seed.

### EXAMPLE 6

### Generation of Coated Seeds that Include Activated Charcoal

This example describes methods used to adhere Zeba® superabsorbent polymer particles and activated charcoal to seashore paspalum ‘Sea Spray’ grass seeds. One skilled in the art will recognize that similar methods can be used to generate coated seeds from other grasses or other plants. This method is similar to that described in Example 1, except that the SAP-containing composition includes activated charcoal (ratio of 100:1 (w/w) activated charcoal: seed). One skilled in the art will recognize that the SAP-containing composition can also include coir. Furthermore, one skilled in the art will appreciate that activated charcoal or coir can be adhered before or after adhering a SAP-containing composition using similar methods.

The inventors have determined that adhering activated charcoal to seed increases the herbicide resistance of the seed, such as an increase of at least 10%, at least 25%, at least 50%, at least 75%, at least 90% or at least 99%. For example, when such seed is planted, the crop or other seed- or plant-containing area can be treated with one or more herbicides to reduce undesirable weed growth, without significantly affecting the viability of the coated seeds. This results in a crop or other treated area that is virtually weed-free (for example less than 0.05% weeds, less than 0.5% weeds, or less than 0.1% weeds). In particular examples, seeds having adhered activated charcoal have increased resistance to the following herbicides: atrazine, Karmex, diuron, and Kerb.

Zeba® was adhered to the seed via a binder to increase the amount of moisture absorbed into the seed coating layer. With Zeba®, cracking will occur in 2 or 3 ‘block’ portions, increasing the opportunities for light and moisture penetration and thereby providing greater chance of germination. Only a relatively small amount of Zeba® is needed to provide these benefits; Zeba® was applied at a rate of 2½% to 3% of the weight of the seed.

An adhesive or binder was used to adhere the Zeba® coating to the seed, by creating a favorable moist surface for the SAP-containing composition (Zeba® powder and filler material). Because Zeba® is a superabsorbent product and absorbs water very readily, polyvinyl alcohol (PVOH) was used as the binder (Celvol® or BF17). A rate of 5 to 6 pounds of powder PVOH to 100 pounds of grass seed was used to provide a sufficiently moist surface for the SAP-containing composition to adhere. The raw seed was exposed to the PVOH binder for 5 to 8 minutes at room temperature to obtain thorough coverage on each seed piece.

The moist seeds coated with PVOH were contacted with the SAP-containing composition, which included finely ground mineral material (plus other additives as desired such as calcium carbonate, clay, gypsum, bentonite, and dry diatomaceous earth) and Zeba®. The mineral material does not substantially dissolve in water and was used to keep the moist seeds from sticking to each other.

After at least partially coating the seed with PVOH, the SAP-containing composition (finely ground filler base-mineral and additives, which may include coir), including 0.5% to 2.5% Zeba® and activated charcoal at a w/w ratio of 1:1 activated charcoal to seed) was exposed to the seed. While the seeds were being tumbled in a drum, the SAP-containing composition was applied to the seeds. The amount of finely ground mineral material, activated charcoal, and Zeba® needed were measured beforehand, and mixed together into a single SAP-containing composition. This ensured that the seeds did not stick to each other and the coating was more consistent. The seeds were tumbled with the SAP-containing composition for about 10 to 12 minutes. This resulted in a coated seed (though 100% coverage by the SAP-containing composition is not required).

The seed was fed into an inclined drum to compact the seed coating and reduce the amount of filler material ‘flaking off’ later in transit or as the seed is handled.

The coated seeds were then immediately dried before too much moisture was imbibed by the seed, causing unwanted pre-germination. A large fluid bed dryer or forced hot air system was used. Coated seeds were heated at 180° F. for 5 minutes or less.

After drying, the coated seed was then screened for size and can be bagged for shipment. The resulting seed's weight and size has increased, but the finished coated seed remained principally the same shape as it was prior to coating.

The total time to coat and process a batch of seed took no longer than 20 to 25 minutes.

In view of the many possible embodiments to which the principles of the disclosure may be applied, it should be recognized that the illustrated embodiments are only examples of the disclosure and should not be taken as limiting the scope of the disclosure. Rather, the scope of the disclosure is defined by the following claims. We therefore claim as our invention all that comes within the scope and spirit of these claims.

We claim:

1. A seed-bulking composition, comprising:
nutshell fragments at least partially coated with a binder; and
super-absorbent polymer (SAP) particles adhered to the nutshell fragments by the binder.

2. The composition of claim 1, wherein the SAP particles are present in a coating composition.

3. The composition of claim 1, wherein the ratio of the nutshell fragments to the coating composition is about 1:1 by weight.

4. The composition of claim 1, wherein the coating composition further comprises filler particles.

5. The composition of claim 4, wherein the filler particles comprise one or more of activated charcoal, calcium carbonate, clay, gypsum, bentonite, coir, and dry diatomaceous earth.

6. The composition of claim 2, wherein the SAP comprises about 0.5 to 5% of the coating composition.

7. The composition of claim 1, wherein the nutshell fragments are about +/−1 mm.

8. The method of claim 1, wherein the SAP comprises a starch-based SAP.

9. The composition of claim 1, further comprising:
seeds coated at least partially with a binder; and
SAP particles adhered to the seeds by the binder.

10. The composition of claim 9, wherein the seeds and nutshell fragments are approximately of equal size.

11. The composition of claim 9, wherein the seeds and nutshell fragments are present at a ratio of about 50% each.

12. The composition of claim 9, wherein the SAP particles adhered to the seeds and the SAP particles adhered to the nutshell fragments comprise the same SAP.

13. The composition of claim 9, wherein the nutshell fragments comprise filbert nutshells and the seeds comprise grass seeds.

14. The composition of claim 9, wherein the seeds further comprise activated charcoal or coir adhered to the seeds by the binder.

15. A method of making a planting mix, comprising:
adhering super-absorbent polymer (SAP) particles to a seed at least partially coated with a binder, thereby generating coated seed;
adhering SAP particles to a bulking agent at least partially coated with a binder, thereby generating a coated bulking agent; and
mixing the coated seed and the coated bulking agent, wherein the coated seed and the coated bulking agent are approximately equal size, thereby generating a planting mix.

16. The method of claim 15, further comprising planting the planting mix, thereby permitting germination of the seed.

17. The method of claim 15, wherein the SAP comprises a starch-based SAP.

18. The method of claim 15, wherein the seed is a grass seed.

19. The method of claim 15, wherein the bulking agent comprises nutshell fragments, vermiculite, perlite, rubber fragments, sand, coir, or combinations thereof.

20. The method of claim 15, wherein the wherein the seed and the bulking agent are within +/−0.5 mm of one another.

21. The method of claim 15, wherein adhering (SAP) particles to the seed at least partially coated with a binder further comprises adhering a bulking agent to the seed.

22. The method of claim 15, wherein the SAP particles are adhered to the seed and to the bulking agent at a rate of 1% to 5% of the weight of the seed or the weight of the bulking agent.

23. The method of claim 15, wherein an approximately equal weight of the SAP particles are adhered to an approximately equal weight of the seed and an approximately equal weight of the bulking agent.

24. The method of claim 15, wherein the coated seed-coated bulking agent mixture has increased germination.

25. The method of claim 15, wherein the seeds further comprise activated charcoal or coir adhered to the seeds by the binder.

26. A method of making a planting mix, comprising:
mixing the composition of claim 1 with coated seed, wherein the coated seed is at least partially coated with a binder and comprises super-absorbent polymer (SAP) particles adhered to the seed by the binder, thereby generating coated seed, and wherein the seed and the nutshell fragments are approximately equal size, thereby generating a planting mix.

27. The method of claim 26, wherein the nutshell fragments consist of filbert nutshell fragments or coir and the seed consists of grass seed.

28. A seed, comprising:
seed at least partially coated with a binder;
super-absorbent polymer (SAP) particles adhered to the seed by the binder; and
activated charcoal or coir adhered to the seed by the binder.
